(19) United States
(12) Patent Application Publication
(10) Pub. No.: US 2026/0152820 A1
(43) Pub. Date: Jun. 4, 2026

(54) Direct Cathode Regeneration Method for Lithium-ion Battery Recycling

(71) Applicants: Zhongwei CHEN, Waterloo (CA); Tingzhou YANG, Waterloo (CA)

(72) Inventors: Zhongwei CHEN, Waterloo (CA); Tingzhou YANG, Waterloo (CA)

(21) Appl. No.: 19/123,051

(22) PCT Filed: Oct. 20, 2023
(86) PCT No.: PCT/CA2023/051394

§ 371 Date: Apr. 21, 2025

Related U.S. Application Data
(60) Provisional application No. 63/380,558, filed on Oct. 21, 2022.

(51) Int. Cl. C22B 7/00; C22B 26/12; H01M 10/54

(52) U.S. Cl. CPC C22B 7/007; C22B 7/008; C22B 26/12; H01M 10/54

(57) ABSTRACT

A method for direct cathode regeneration from spent lithium-ion batteries. The method includes treating black mass with organic acids to leach the valuable metal elements, and the residual impurities removal by filtration and further treatment of the material with different leaching solutions to achieve the desired ratio of components which are subsequently precipitated as the hydroxide intermediate, followed by a two-step annealing process to obtain a regenerated cathode material.

### CROSS REFERENCE TO PRIOR APPLICATIONS

The present application claims priority to U.S. Application No. 63/380,558, filed Oct. 21, 2022, the entire contents of which are incorporated herein by reference.

### FIELD

The present description relates to a direct cathode regeneration method for recycling the cathode materials of spent lithium-ion batteries. In one aspect, the method allows waste material and particularly valuable metals from spent Li-ion batteries to be regenerated in a form suitable for recycling.

### BACKGROUND

After a decade of rapid growth, electric vehicle sales accounted for more than 9% of the global car market in 2021, which is four-time higher than their market share in 2019. It is predicted that, the global lithium-ion (Li-ion) battery production capacity will reach over 6,000 GWh by the end of the decade. The average lifespan of Li-ion batteries is about 3-8 years after which the batteries are disposed of. Disposal of spent batteries can lead to environmental pollution. As the number of spent batteries increases the problem of spent battery disposal will only grow. Therefore, safe disposal methods are needed. Recently, the reuse of spent Li-ion batteries has been investigated to relieve some of this pressure, but all batteries have a retirement schedule.

Meanwhile, Li-ion batteries contain Li, Co, Mn, Ni, and other high-value metals. As the production of Li-ion batteries increases, significant pressure is imposed on the supply of Li, Ni, and Co, which will eventually face a serious shortage. In the face of such shortages, waste material from Li-ion batteries may also represent a valuable resource. In spent Li-ion batteries, the concentration of Li (5-7 wt %), Co (5-20 wt %), and Ni (5-10 wt %) are far higher than in the natural resource, making Li-ion battery recycling very beneficial and desirable from an environmental and economic point of view.

To date, physical dismantling, crushing, sieving, and mechanochemical treatment have been widely adopted to separate various components inside the spent Li-ion batteries. The shredded material is then processed to produce black mass, containing high amounts of valuable metals including Li, Ni, Co, Mn, Al, and Cu. Chemical methods based on pyrometallurgy and hydrometallurgy are used in combination to separate each element. However, the impurities in the black mass reduce the purity of the separation and the metal separation is therefore less profitable. Direct cathode regeneration methods enable the regeneration of spent cathode materials into new materials while avoiding intensive energy and chemical usage, resulting in significant cost and secondary waste reductions. Few studies 7 have been undertaken to design direct cathode regeneration methods. For example, Wang Y. et al in U.S. Pat. No. 11,127,992) and Ma X. et al. in their publication (J oule, 2021, 5, 2955-2970.) 9 have adopted the same process design for the regeneration of recycled cathode materials using sulfuric acid-based leaching process and high-temperature annealing processes. Yang L. et al., (Ceramics International, 2015, 4, 11498-11503.) and Sencanski J. et al., (Journal of Power Sources, 2017, 342, 690-703) in their publication report on a nitric acid-based leaching process, the co-precipitation method, followed by a thermal treatment to resynthesize the cathode materials. However, new methods are still needed for efficient and environmentally friendly regeneration of cathode material from spent Li-ion batteries.

### SUMMARY

In one aspect there is provided a method of regenerating cathode material from spent Li-ion batteries comprising:
processing spent Li-ion batteries to produce a black mass,
leaching the black mass with an organic acid,
filtering the leaching solution to remove impurities,
treating the leaching solution with base to convert Ni, Co and Mn in the solution to corresponding hydroxide intermediates and separating the hydroxide intermediates from the leaching solution by filtration,
combining the hydroxide intermediates with a lithium source,
mixing and reducing particle size by ball milling,
adding special additives to avoid caking and improve productivity,
annealing the mixture at two-step temperatures to form a regenerated cathode material.

### BRIEF DESCRIPTION OF THE DRAWINGS

Embodiments will now be described with reference to the appended drawings wherein:

FIG. 1 is a schematic of disassembling process for spent Li-ion battery recycling.

FIG. 2 is a schematic of the organic-acid-based leaching process.

FIG. 3 is a schematic of the cathode regeneration process.

FIG. 4 is a graph showing the X-ray diffraction (XRD) pattern of the obtained Li₂CO₃ in Example A and Example B.

FIG. 5 is a graph showing the XRD pattern of the obtained LiNiCoMnO₂ and LiNi_{0.8}Co_{0.1}Mn_{0.1}O₂ in Example A and Example B.

FIG. 6 is a scanning electron micrograph (SEM) image of the obtained LiNiCoMnO₂ in Example A.

FIG. 7 is a schematic of the high-value metal separation steps, recovery step, and purification steps

### DETAILED DESCRIPTION

### Definitions

Unless stated otherwise herein, the articles “a” or “the”, when used to identify an element, are not intended to constitute a limitation of just one and will, instead, be understood to mean “at least one” or “one or more”. Thus, unless stated otherwise, as used in this specification and the appended claims, the singular forms “a”, “an”, and “the” will be understood to include the plural form. For example, reference to “a container” will be understood to include one or more of such containers and reference to “the excipient” will be understood to include one or more of such excipients.

As used herein, the term “about” is synonymous with “approximately” and is used to provide flexibility to a numerical value or range endpoint by providing that a given value may be “a little above” or “a little below” the value stated. “About” can mean, for example, within 3 or more than 3 standard deviations. “About” can mean within a percentage range of a given value. For example, the range can be ±1%, ±5%, ±10%, ±20%, ±30%, ±40% or ±50% of a given value. “About” can mean with an order of magnitude of a given value, for example, within 2-fold, 3-fold, 4-fold, or 5-fold of a value. However, it is to be understood that even when a numerical value is accompanied by the term “about” in this specification, that express support shall be provided at least for the exact numerical value as well, as though the term “about” were not present.

The terms “comprise”, “comprises”, “comprised” or “comprising” may be used in the present description. As used herein (including the specification and/or the claims), these terms are 4 to be interpreted as specifying the presence of the stated features, integers, steps or components, but not as precluding the presence of one or more other feature, integer, step, component or a group thereof as would be apparent to persons having ordinary skill in the relevant art. Thus, the term “comprising” as used in this specification means “consisting at 8 least in part of”. When interpreting statements in this specification that include that term, the features, prefaced by that term in each statement, all need to be present but other features can also be present. Related terms such as “comprise” and “comprised” are to be interpreted in the same manner.

The term “and/or” can mean “and” or “or”.

As used herein, “comprises,” “comprising,” “containing” and “having” and the like can have the meaning ascribed to them in patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with patent law.

The phrase “consisting essentially of” or “consists essentially of” will be understood as generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open-ended term, such as “comprising” or “including”, it will be understood that direct support should be afforded also to “consisting essentially of” language as well as “consisting of” language as if stated explicitly and vice versa. In essence, use of one of these terms in the specification provides support for all of the others.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but to also include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but to also include individual values and sub-ranges within the indicated range. Thus, included in this numerical range are individual values such as 2, 3, and 4 and sub-ranges such as from about 1 to about 3, from about 2 to about 4, and from about 3 to about 5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

The present description is directed to methods for recycling material from spent Li-ion batteries. The material for recycling can be obtained from a single spent battery or single type of battery or from different spent batteries mixed together. In particular, the methods is for regenerating high value cathode materials such as Li, Ni, Co and Mn. Notably this method does not require additional screening steps based on different cathode materials during the initial spent battery disassembling process.

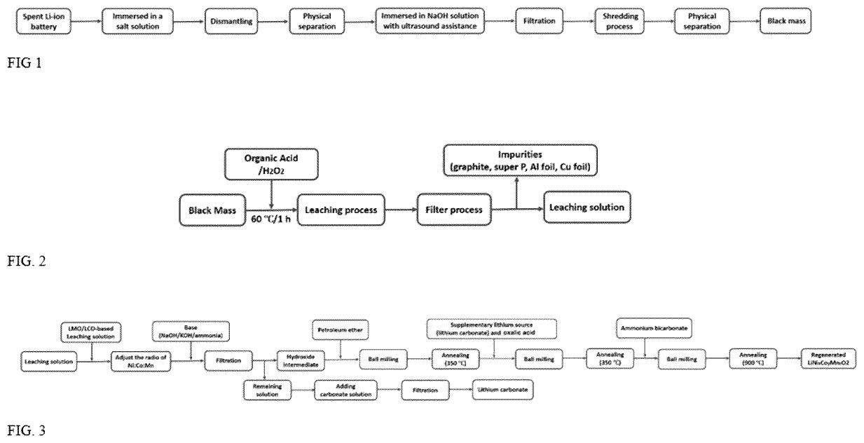

In one aspect, the description provides a method of cathode regeneration including a series of processes as shown in FIG. 1, FIG. 2, and FIG. 3.

Once a Li-ion battery reaches the end of its service life, it is collected and dismantled. As shown in FIG. 1, spent Li-ion battery material is converted into black mass through a series of steps. The steps include immersion in a salt solution, dismantling, physical separation, immersion in base solution, followed by filtration, shredding and physical separation to yield the black mass material.

In an embodiment, the spent batteries are fully immersed in a salt solution or brine for 3-8 days to remove the residual energy inside batteries. In a further aspect the salt solution is 2.0-5.0 M sodium chloride or potassium chloride solution. In a further aspect the salt solution can be replaced with seawater.

In one aspect the treatment with base solution comprises treatment with 10.0 M NaOH solution or N-Methyl-2-pyrrolidone solution. In a further aspect, ultrasound was used to help the active materials detach from the current collector. In a particular embodiment ultrasound was applied to the material in the base solution for about 2 to about 10 hours.

In a further aspect the resulting black mass comprises one or more of lithium cobalt oxide, lithium manganite oxide, lithium nickel cobalt manganite oxide, residual conductive carbon materials, anode materials, residual copper foil, and residual aluminum foil. The residual impurities can be removed by the following filtration steps.

As shown in FIG. 2 a leaching procedure with a high metal leaching rate has been designed using organic acids and additives. Suitable organic acids include acetic acid, phytic acid, malic acid, citric acid, and oxalic acid. Compared with mineral acid, the organic acids used are more environmentally friendly. The leaching rate and temperature for the organic acids was found to be comparable to that of mineral acids (see TABLE 1).

The organic acid leaching solution can further include one or more additives, such as hydrogen peroxide, sodium perchlorate, and potassium perchlorate. In one embodiment the additive is hydrogen peroxide. In a particular embodiment the additive is 1-5 vol % hydrogen peroxide. In a specific embodiment the leaching step is conducted at about 40 to about 80° C. for about 0.5 to about 2.0 hour.

TABLE 1

| | Solid- | | | Leaching | |
|---|---|---|---|---|---|
| | liquid | | Leaching | efficiency of | Leaching |
| Acid | ratio | Temperature | efficiency of Ni | Co | efficiency of Mn |
| Oxalic acid | 40 | 75° C. | 98% | 98% | 98% |
| Citric Acid | 28 | 85° C. | 97% | 96% | 98% |
| Malic acid | 25 | 85° C. | 96% | 97% | 97.5% |
| Acetic acid | 39 | 70° C. | 99% | 98% | 99% |
| Phytic acid | 45 | 80° C. | 99% | 99% | 99% |

first filtration process is used to remove residual impurities, such as Al foil, Cu foil, binder, graphite anode materials, and conductive carbon materials, in the leaching solution (FIG. 2). The filtration can be caried out using ordinary filter paper. For large-scale application, this step can be replaced by a Backflow filter. The present inventors have found that if impurities are not removed, the performance of the regenerated cathode is adversely affected.

Further processing steps of the method are shown in FIG. 3. The dissolved cathode materials in the leaching solution can be treated with pure lithium manganite oxide (LMO) leaching solution, pure lithium cobalt oxide (LCO) leaching solution, or metal sulfate to adjust the molar ratio of the leaching solution to adjust the ratio of Ni:Co:Mn. The pure LMO/LCO leaching solution are obtained by dissolving the corresponding raw materials in the same leaching agents. The metal sulfate can be manganese sulfate, nickel sulfate or cobalt sulfate. The adjusted ratio of Ni:Co:Mn is 1:1:1, 5:2:3, and 8:1:1.

The leaching solution is then treated with base to convert the dissolved cathode materials into hydroxide intermediates. The base can be a mixture of 2.0-5.0 M ammonia and 5-10 M NaOH or KOH solution, or, at a pH value of 10.5-11.5, at room temperature. Following treatment with base, the hydroxide are filtered out of the solution.

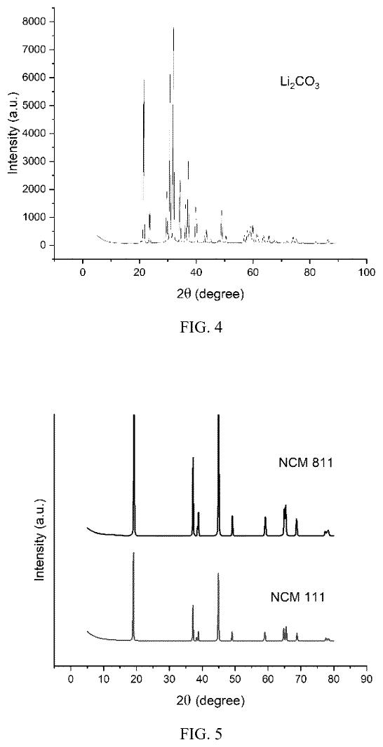

Carbonate solution was added to the remaining leaching solution, to generate lithium carbonate which was then removed by filtration. The XR D identification of the lithium carbonate filtrate is shown in FIG. 4. The obtained lithium carbonate can be sold or used in the regeneration process.

As shown in FIG. 3, the metal hydroxide intermediate then undergoes successive annealing and ball milling steps. The petroleum ether and ammonium bicarbonate or oxalic acid were added to avoid yield loss due to caking during the annealing process. The ball milling method is used for homogeneous mixing of the hydroxide intermediates and lithium sources. The method includes at least two annealing step and may include additional annealing steps. The method also includes multiple ball milling steps. In a particular embodiment the method includes 3 ball milling steps. In a particular aspect, the hydroxide intermediate is combined with petroleum ether and mixed in a first ball milling step followed by a first annealing step at a temperature of 300-400° C. The first annealing step is followed by optional addition of a supplementary lithium source such as lithium carbonate, lithium hydroxide, or lithium chloride. The petroleum ether was added to ensure uniform mixing. The ammonium bicarbonate, oxalic acid are added to avoid the caking of the particles. A second ball milling step is followed by a second annealing step at a temperature of 300-400° C. The second annealing step is followed by addition of ammonium bicarbonate or oxalic acid. A third ball milling step is followed by a third annealing step at a temperature of 750-1200° C. In one embodiment the mass ratio between ball and materials is 20-500:1, the ball milling speed is about 300 to about 400 rpm and the duration of the ball milling is about 2 to about 4 hours.

Following the first annealing step, a supplementary lithium source may be added to compensate for lithium loss during the high-temperature annealing process. In one embodiment the step comprises addition of 5-10 wt % lithium salt.

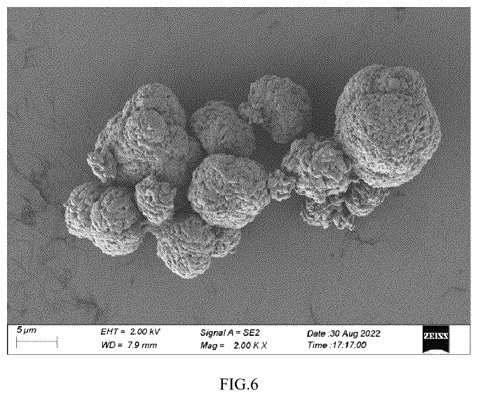

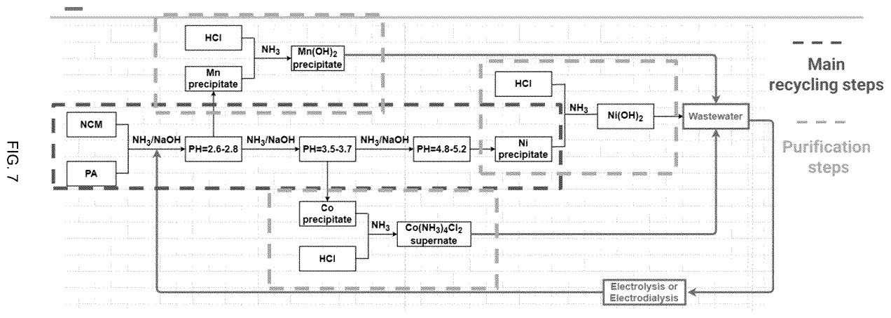

Following the annealing and ball milling steps a regenerated cathode materials is prepared. In particular, there is a solid-state reaction in two annealing processes. The generated material has the general formula LiNiₓCo_{y}Mn₂O₂. Customize cathode materials with different metal ratios can be produced by this method. FIG. 5 shows the XRD patterns for two materials having different metal ratios obtained by the regeneration method and FIG. 6 is an SEM image of a material obtained by the method.

FIG. 7 shows a scheme for recovering Mn Co, and Ni precipitates. In a further aspect a wastewater recovery system may be added to construct a closed-loop battery recycling system. Electrolysis and electrodialysis methods are used to concentrate wastewater and obtain O₂/H₂ gas at the same time.

A comparison of commercially available material to recycled material prepared by the regeneration methods is provided in Table 2. The results show excellent electrochemical performance of the regenerated material.

TABLE 2

| | | Capacity at 0.2 C | Capacity retention |
|---|---|---|---|
| Raw material | Li Source | (mAh/g) | (100 cycles) |
| Commercial LCO | Commercial Li₂CO₃ | 167 | 93.8% |
| Commercial NCM | Commercial Li₂CO₃ | 145 | 92.0% |
| Our regenerated LCO | Recycled Li₂CO₃ | 167 | 98.9% |
| Our regenerated NCM | Recycled Li₂CO₃ | 166 | 99.3% |

### EXAMPLES

### Example A

The spent Li-ion battery was collected and immersed in a salt solution or brine for several days to realize full discharge. Physical separation was used to remove the battery cases and separator after the dismantling process. Then, the extra components were immersed in a 10.0 M NaOH solution with ultrasound assistance, where the cathode materials detach from the current collector. The shredding process was used to produce the black mass. The black 8 mass was leached in a 3.5 M acetic acid solution with 3.0 vol % H₂O₂ at 70° C. for 1.0 h. After filtration, the pure lithium manganite oxide (LMO) leaching solution, pure lithium cobalt oxide (LCO) leaching solution, or metal sulfate was added to adjust the molar ratio of Ni, Co, and Mn to 1:1:1, and 5.0 M NaOH solution and 2.5 M ammonia solution were slowly added to adjust the pH value to 10.5-11.5. By filtration, the hydroxide intermediates can be separated. Then, 75 g/L NaOH solution was added to the remaining solution at 60° C. for 1.0 h, and lithium carbonate was filtered. 20.0 g hydroxide intermediates and 15.0 ml petroleum ether were subject to ball-milling at 300 rpm for 2.0 h. After annealing at 350° C. for 3.0 h in the air, 1.06 mol % lithium carbonate and 1.5 wt % oxalic acid were subject to ball-milling at 400 rpm for 4.0 h. The mixture was heated at 900° C. for 10.0 h. The resulting product was LiNiCOMnO₂.

### Example B

The spent Li-ion battery was collected and immersed in a salt solution or brine for several days to realize full discharge. Physical separation was used to remove the battery cases and separator after the dismantling process. Then, the extra components were immersed in a 10.0 M NaOH solution with ultrasound assistance, where the cathode materials will detach from the current collector. The shredding process was used to produce the black mass. The black mass in a 3.0 M Phytic acid solution with 2.0 vol % H₂O₂ was leached at 80° C. for 1.0 h. After filtration, the pure LMO leaching solution, pure LCO leaching solution, or metal sulfate was added to adjust the molar ratio of Ni, Co, and Mn to 8:1:1, and 5.0 M NaOH solution and 2.5 M ammonia solution were slowly added to adjust the pH value to 10.5-11.5. By filtration, the hydroxide intermediates can be separated. Then, 77 g/L NaOH solution was added to the remaining solution at 60° C. for 1.0 h, and lithium carbonate was filtered. 20.0 g hydroxide intermediates and 15.0 ml petroleum ether were subject to ball-milling at 300 rpm for 2.0 h. After annealing at 350° C. for 3.0 h in the air, 1.06 mol % lithium carbonate and 1.5 wt % oxalic acid were subject to ball-milling at 400 rpm for 4.0 h. The mixture was heated at 900° C. for 10.0 h. the resulting product was and LiNi_{0.8}Co_{0.1}Mn_{0.1}O₂.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the claims appended hereto should not be limited by the preferred embodiments set forth in the above description but should be given the broadest interpretation consistent with the present specification as a whole. The disclosures of all prior art recited herein are incorporated herein by reference in their entirety.

What is claimed is:

1. A method of regenerating cathode material from spent Li-ion batteries comprising:
processing spent Li-ion batteries to produce a black mass;
leaching the black mass with an organic acid;
filtering the leaching solution to remove impurities;
treating the leaching solution with base to convert Ni, Co and Mn in the solution to corresponding hydroxide intermediates and separating the hydroxide intermediates from the leaching solution by filtration;
combining the hydroxide intermediates with a lithium source;
mixing and reducing particle size by ball milling;
adding additives to avoid caking and improve productivity;
annealing the mixture at two-step temperatures to form a regenerated cathode material.
